(19) United States
(12) Patent Application Publication
(10) Pub. No.: US 2009/0046577 A1
(43) Pub. Date: Feb. 19, 2009

(54) RESUMING AN INTERRUPTED FLOW OF DATA PACKETS

(75) Inventor: James S. Marin, Murphy, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/838,514

(22) Filed: Aug. 14, 2007

(51) Int. Cl. G01R 31/08; H04B 7/00; H04L 12/66

(52) U.S. Cl. 370/219; 370/310; 370/355

(57) ABSTRACT

A system and method for resuming an interrupted flow of data packets from a sender to an intermediate node in a path between the sender and a mobile device includes a first step 102 of storing a history of data packets sent to the mobile device. A next step 104 includes interrupting the flow of data packets. A next step 106 includes providing a sequence number pointers in a flow control protocol to the restart sequence number determining processor, the sequence number pointers indicating a best position in the flow of data packets for restarting packet flow. A next step 108 includes resuming the flow of data packets from the history starting at a packet indicating by the sequence number pointer decided by the restart sequence number determining processor.

### TECHNICAL FIELD OF THE INVENTION

This invention relates generally to wireless communication systems and more particularly to wireless communication systems that resume an interrupted flow of data packets.

### BACKGROUND OF THE INVENTION

Typical wireless communication systems include a mobile station, such as a radiotelephone, wirelessly networked computer, access terminal or other wireless communication device that transmits packet data through a stationary transceiver, commonly known as a base station or access point, which is connected to a network gateway such that information may be shared with other communication systems. For example, Third Generation Partnership Project (3GPP), 3GPP2 and WiMax (IEEE 802.xx) communication systems each involve radio access networks that route Internet Protocol (IP) traffic between a media gateway and base stations.

Because the mobile stations move relative to the base stations, eventually the wireless signal will weaken to the point that the mobile station will need to switch its wireless communication to another base station having a stronger signal. As a result, the routing of information is dynamic depending upon a movement of the mobile station. As the mobile station moves amongst coverage by different base stations, the route between the mobile station and the gateway is adjusted. The problem is to move the connection route to the mobile station without losing data that may have already been sent from the gateway but not yet fully received at the mobile station. The data that is potentially lost is typically data that; has been sent but not acknowledged by the mobile station, data queued at the base station, or data that is in transit between the access gateway and the base station. The problem is further complicated by the fact that it may not matter if some types of data (i.e. real time voice) are lost; whereas, other types of data (i.e. HyperText Meta Language (HTML), Transfer Control Protocol (TCP) traffic, secure traffic, and signaling messages) should be transmitted if at all possible.

Wireless communication systems employ various known techniques to facilitate the transfer of a mobile station from one base station to another. Certain wireless communication systems will wait until the system determines that the mobile station needs to transfer base stations to begin a transfer of data. In such a system, the transfer cannot occur until the mobile station signals to the system that a transfer should occur, which results in an unacceptable delay in the operation of the system for the mobile station user.

In certain high speed networks, a central server will forward the data to be sent to a mobile station to every base station in the active area of the mobile station at a given frequency or at certain times or intervals to reduce the delay experienced during a handoff. In other words, the system will send the data to not only the base station with which the mobile station is communicating, the primary base station, but also to every base station to which the mobile station may switch its communication surrounding that primary base station. This flooding technique results in larger data traffic volumes within the network as data is needlessly sent to multiple base stations. The larger data volumes, in turn, can overly tax the system's resources.

Other communications systems teach of having one base station re-route packets to another base station once the location of the new base station is known, but these re-routing techniques either require inter-base station connectivity or unnecessarily delay resumption of packet flow. In all of the previous solutions, packet data can become stranded, lost, or unnecessarily retransmitted.

What is needed is a technique where data traffic flow following a mobility event of the mobile station is re-established as quickly as possible, while minimizing the chance that data packets may become stranded, lost, or unnecessarily retransmitted.

### BRIEF DESCRIPTION OF THE DRAWINGS

The above needs are at least partially met through provision of the method and apparatus for base station synchronization described in the following detailed description, particularly when studied in conjunction with the drawings, wherein:

FIG. 1 is a block diagram of a wireless communication system as configured in accordance with various embodiments of the present invention;

FIG. 2 is a diagram of a packet flow in the wireless communication system of FIG. 1 as configured in accordance with various embodiments of the present invention;

FIG. 3 is a line diagram depicting a method in accordance with a first embodiment of the present invention;

FIG. 4 is a line diagram depicting a method in accordance with a second embodiment of the present invention;

FIG. 5 is a diagram of a data protocol stack in accordance with the present invention;

FIG. 6 is a diagram of 3GPP2 GRE Encapsulated User Traffic in accordance with the present invention;

FIG. 7 is a diagram of the structure of the 3GPP2 GRE frame of FIG. 6;

FIG. 8 is a diagram of an attribute format in accordance with the present invention;

FIG. 9 is a diagram of the flow of packet data in the forward direction by including XON/XOFF signals in GRE frames sent to a gateway in accordance with the present invention;

FIG. 10 is a flow diagram of a method in accordance with the present invention; and

FIG. 11 is a diagram showing the inputs used to determine the restart sequence number in accordance with the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Pursuant to various embodiments, the present invention provides a system and method for resuming an interrupted flow of data packets from a sender to an intermediate node in a path between the sender and a mobile device. The interrupted flow can be due to a mobility event or just a hold condition on the connection flow. In particular, the present invention provides an enhanced flow control technique that enables restart of packet flow while minimizing retransmission of packets. Specifically, the present invention dynamically determines the best restart point to use for restarting packet flow due to a hold or handoff/handover event. In practice, and unlike TCP which assumes a fixed session route, this disclosure deals with a changing route of the IP-layer traffic that flows under the TCP layer.

Advantageously, data traffic flow following an interruption is re-established as quickly as possible, while minimizing the chance that data packets may become stranded, lost, or unnecessarily retransmitted. This disclosure can take advantage of inter-base station communication, if it exits, but still provides a benefit in systems that have no inter-base station communication paths.

Although the present invention as described herein refers to a 3GPP2 UMB IOS (Ultra Mobile Broadband Inter-Operability Specification) forward link flow control, it should be recognized that the present invention is equally usable in other communication systems, such as 3GPP, 3GPP2, and WiMAX, that involve a re-starting of an interrupted flow of data packets.

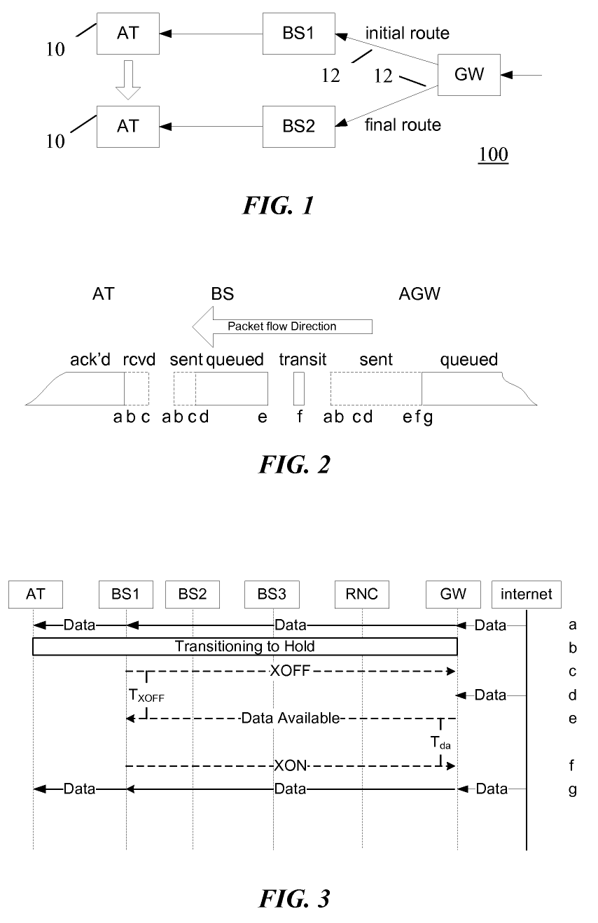

Referring now to FIG. 1, a simplified wireless communication system 100 is provided including a mobile station 10 in wireless communication with a primary base station, BS1. The primary base station BS1 can be identical to or similar to the neighboring base stations BS2 elsewhere in the wireless communication system. Alternatively, BS2 can be a different age or type allowing, for example, old base stations without the capabilities of this invention to be used beneficially with new base stations that support the invention and base stations of different types to allow the AT to switch modes (e.g. 3GPP2 and 3GPP) as the AT moves between coverage of BS1 and BS2. Other network elements (as are known in the art) are also present but are not shown for the sake of simplicity. The base stations are networked or otherwise in communication with an access gateway, GW (or AGW) through a tunnel 12.

In the example described herein, the present invention enhances the flow control protocol for the Access Gateway Evolved Base Station (AGW-eBS) (U1) Tunnel, using IPV6 in an end-to-end application, for example. In particular, the invention deals with basic XON/XOFF flow control for independent forward and reverse U1 tunnels, where XON/XOFF functions start and stop transmissions, respectively, as is known in the art. Although the U1 tunnel exists under various names in 3GPP, 3GPP2, and WiMax, it should be recognized that the present invention is equally applicable to each of these variations.

FIG. 1 shows a simplified model of forward data moving from the gateway (GW) to the access terminal (AT) by routing either through base station 1 (BS1) or Base Station 2 (BS2). However, the network element terms AT, BS and GW exist under various names in different communication systems. For example, in the 3GPP2 UMB communication system, GW is the AGW, AT is the AT, and BS is the eBS. For the 3GPP SAE/LTE (System Architecture Evolution/Long Term Evolution) communication system, GW is the Serving SAE GW, BS is the Evolved UMTS Terrestrial Radio Access Network (EUTRAN), and AT is the UE. For the WiMAX communication system, AT is the MS, BS is the BS, and GW is the ASN GW. Data flow along the initial route may or may not be suspended at the time the AT moves from the coverage of BS1 to the coverage of BS2.

In one embodiment, data flow is simply suspended (held) by any of the network elements and must be resumed. In another embodiment, data flow is interrupted by a mobility event of the mobile device between base stations. Specifically, data flow is suspended on an initial route and resumed on the final route as the AT moves from the coverage of BS1 to the coverage of BS2.

FIG. 2 shows a stream of forward packets along an initial route. At any instant of time, packets at various points in the path are indicated by the letters below the packet stream as will be detailed below. The dotted boxes indicate history buffers in any or all of the AT, BS and GW. Each letter in the packet flow represents possible points to restart packet flow following an interruption or mobility event. For the AGW, current communication protocols allow restart only at point g, whereas the present invention allows restarting at any of points a through g, as will be described below.

Packet a is the last packet fully received by the AT and located at the AT. If the air interface protocol supports packet acknowledgement, then this is the last packet acknowledged by the AT. This last packet can also take into account the re-ordering of out-of-sequence packets. If the air interface protocol does not support packet acknowledgement, then this is the last packet the BS assumes the AT has fully received. The packet can fall off the end of the sent (i.e. history) buffers, indicated by the dotted rectangle, at the BS and GW.

Packet b is the next packet to be fully received at the AT. A copy of the packet is maintained at the BS and GW. If the AT requests retransmission of the packet, the BS retransmits the packet using a copy of the packet from the BS sent buffer. If the AT moves to the coverage by another BS, the GW retransmits the packet using a copy of the packet in the GW sent buffer.

Packet c is the last packet sent to the AT by the BS but not yet fully received by the AT.

Packet d is the next packet that the BS will send to the AT.

Packet e is the last packet received at the BS from the GW.

Packet f represents packets that may be in transit from the GW to the BS. For example, packets in layer 2 hubs and layer 3 routers for an IP network between the BS and GW would be considered in transit.

Packet g is the next packet the GW will send to the BS.

The problem addressed by the present invention is how to avoid losing packets b thru f, when the route is moved from one BS to another (as shown in FIG. 1). Various schemes have been proposed. One scheme is to simply minimize the packets stored at the BS and drop packets b thru f. Another scheme is to re-route some or all of packets b through f to the new BS using, for example, an inter-BS tunnel.

However, the present invention proposes to have the GW (or BS or AT) keep a history of packets. This length of the history buffer is sufficient to include all packets not yet acknowledged by the AT and considers the possible re-ordering of out-of-sequence packets (assuming the air interface is an acknowledge type protocol). (For some air interface protocols the BS simply transmits the packet to the AT and assumes, without acknowledgement, that the packet is received.) To communicate the sequence number associated with point a to the GW, the flow control protocol is extended to include a sequence number pointer. When an XOFF message is sent a sequence number (e.g. point a) is included. If the AT moved to a different BS while the path is in an XOFF state and more packets arrive for delivery, the GW can resume sending with the last packet received by the AT instead of the next packet the GW would have sent, which is one of the possible result from the restart sequence number determining process explained below.

The XOFF/XON terminology is historically an “in-band” protocol in which an ASCII characters AS and AQ were sent to stop and start data flow. In the present invention, the terms XOFF and XON are used generally to mean a method of signaling a halt and resumption, respectively, of sending data on the bearer path. For this contribution, XOFF and XON may be coded either using “in-band” signaling, such as embedded in the Generic Routing Encapsulation (GRE) protocol known in the art, or using “out-of-band” signaling via control or signaling plane messages that accomplish a halt and resumption function.

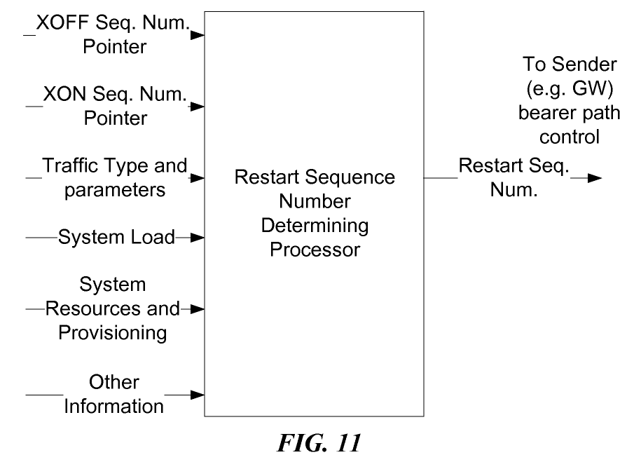

Referring to FIG. 11, the restart sequence number determination processor uses a collection of information to determine the best restart sequence number. The information may include any or all of the following: XOFF sequence number pointer, the XON sequence number pointer, the traffic type and parameters, current system load, available system resources as provisioned, and other information. The XOFF sequence number pointer is determined by the entity signaling the halt of traffic flow. The halting entity may take into account AT and BS buffering, air interface protocol acknowledgement, upper layer traffic information such as traffic type (e.g. voice, video, data), quality of service information for the traffic, encryption and encryption frame boundaries of the upper-layer traffic, frame boundaries for video and voice, necessity to resume real-time traffic versus simply allowing a gap, present load factor, and other information. The halting entity determines a best estimate of a sequence number to resume transmission on and includes the sequence number pointer in the XOFF message. Likewise, the resuming entity takes into account a similar set of information as the halting entity and determines a best estimate of the sequence number to resume transmission on and includes the sequence number pointer in the XON message. Typically, the XON pointer is more recent that the XOFF pointer so the restart pointer determining entity takes into account the latest pointer. The restart determination process uses available information to determine the actual restart sequence number that is passed to the GW bearer path control. For the subsequent description, the signaling assumes that the restart determination processor is located in the GW, but it is pointed out that the restarted determination process may be located in one or more BSs or may be distributed between the BSs and GW with appropriated adjustment of the information that is signaled between the entities.

The change in a route for packet flow (FIG. 1), can appear as a security compromise known as a “man-in-the-middle” attach. Packets are initially routed through BS1 and then later routed through BS2 can make BS2 appear as the man-in-the-middle. In determining the restart sequence number, it is important to select a point in the packet stream that avoids triggering a man-in-the-middle attack alert.

The choice of what sequence number pointer to include in the XOFF and XON message can depend on the type of traffic. It may not matter if some types of data (i.e. real time voice) are lost; whereas, other types off data (i.e. HTML, TCP traffic, secure traffic, and signaling messages) should be transmitted if at all possible.

For this example, the BS extracts the payload from the GRE packet and may segment or assemble the GRE payload into “over the air” packets. However, the BS keeps track of when all of the payload from a particular GRE packet have been fully received by the AT.

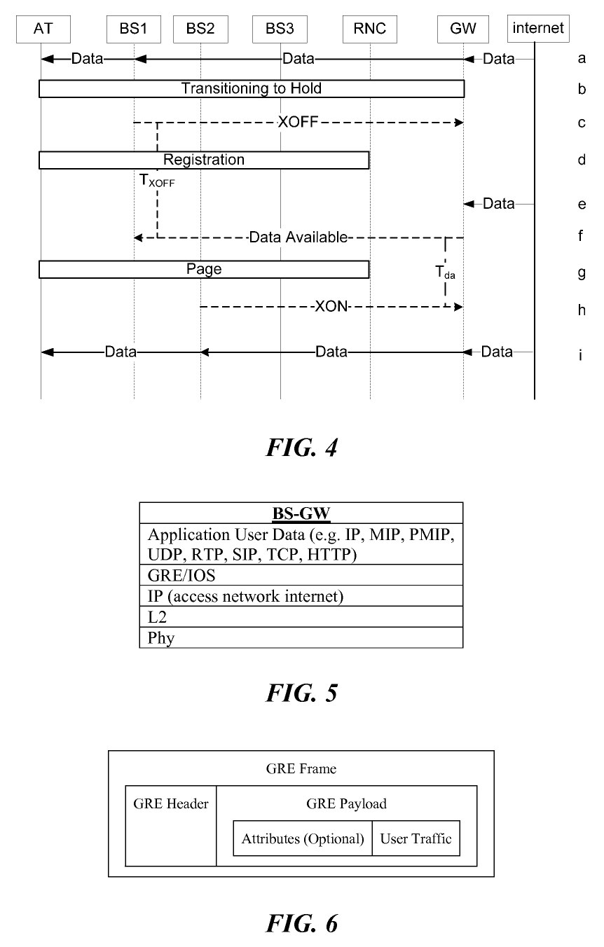

Referring to the call flows of FIGS. 3 and 4, dotted lines indicate signaling plan messages, and solid lines indicate user plan (i.e. bearer) data.

In the first forward link flow control embodiment of FIG. 3, the AT stays within initial BS coverage during a hold state. The AT, while in a data session, goes to an hold state and halts data flow. The AT stays within the coverage area of the BS that was previously transmitting data. New data arrives at the GW, and data flow resumes. Data that may have been stored at the BS during the hold period is released to the AT or, if the BS deleted any buffered data during the hold period, the GW can retransmit the data. New data buffered in the GW is released to the BS beginning at the restart sequence number as determined by the restart sequence number determining processor.

In step a, the AT is active in a packet session. The data is flowing from an unspecified internet location to the AT via the GW and BS1.

In step b, the AT, BS, or GW decides to suspend data transfer and initiates a hold procedure that prepares BS1 for a data hold state. BS1 may buffer data that was queued in BS1 including data not yet fully acknowledged by the AT.

In step c, the BS1 sends a XOFF message to the GW. The XOFF message contains the sequence number pointer of the next packet to be transmitted to BS1. If BS1 buffers data, then the next packet to be transmitted to the BS1 is the next packet that the GW would have sent prior to the hold (see FIG. 2, point g). Alternately, if BS1 does not buffer packets, then the next packet the GW should send is the next packet that the AT was to have acknowledged (see FIG. 2, point b) or possibly the next packet that the BS would have sent to the AT prior to the hold (see FIG. 2, point d). There are many other possibilities of which packet to identify as the next packet the GW should send including an adjustment for possibly out-of-sequence packets. The GW maintains a history of sent packets up to the length of the next packet to be acknowledged by the AT. BS1 starts timer T_{XOFF}. In step d, the data arrives at the GW for the AT. Because the last message received at the GW from a BS is XOFF, the GW buffers the data.

In step e, the GW sends a Data Available message to the BS1. The BS1 stops timer T_{XOFF}, and the GW starts timer T_{da}.

In step f and after a paging process (not shown) to locate and alert the AT of the arrival of new data, BS1 sends a XON message to the GW with a sequence number pointer of the next packet that the GW should send to the BS. As and example of one determination and if the BS1 buffered packets, the next packet would be the next packet the GW would have sent prior to receiving the XOFF message. If the BS1 does not buffer packets, the XON message indicates the next packet after the last packet acknowledged by the AT. The GW stops timer T_{da}.

In step g, the GW resumes sending Data to the BS1 beginning with the packet indicated in the XON message. BS1 sends Data to the AT beginning with any packets buffered at the BS followed by additional Data received from the GW.

In the second forward link flow control embodiment of FIG. 4, the AT moves to another BS coverage during hold state. The AT, while in a data session, holds and moves to the coverage area of another than the BS that was previously transmitting data. New data arrives at the GW. Data flow resumes by having the GW send it's copy of the data previously sent to BS1 but not yet fully received by the AT prior to going on hold. This flow applies to a handoff scenario (i.e. active data transfer) as well as dormant (i.e. idle) scenarios.

In step a, the AT is active in a packet session. The data is flowing from an unspecified internet location to the AT via the GW and BS1.

In step b, the AT, BS, or GW decides to suspend data transfer and initiates a hold procedure that prepares BS1 for a data hold state. The hold may be due to a handoff or may simple be due to transition to an idle or dormant state. BS1 may buffer data that was queued in BS1 including data not yet fully acknowledged by the AT.

In step c, BS1 sends a XOFF message to the GW. The XOFF message contains the sequence number of the next packet to be transmitted to BS1. If BS1 buffers data, then the next packet to be transmitted to the BS1 is the next packet that the GW would have sent prior to the hold (see FIG. 2, point g). Alternately, if BS1 does not buffer packets, then the next packet the GW should send is the next packet that the AT was to have acknowledged (see FIG. 2, point b) or possibly the next packet that the BS would have sent to the AT prior to the hold (see FIG. 2, point d). There are many other possibilities of which packet to identify as the next packet the GW should send. The GW maintains a history of sent packets up to the length of the next packet to be acknowledged by the AT. BS1 starts timer T_{XOFF}.

In step d, the AT moves to the coverage area of BS2 and initiates a Registration procedure which informs BS1 that the AT is now located in the coverage area of BS2.

In step d, data arrives at the GW for the AT. Because the last message received from a BS was an XOFF message, the GW buffers the data.

In step e, the GW sends a Data Available message to BS1. BS1 stops timer T_{XOFF}. The GW starts timer T_{da}.

In step g, BS1, knowing that the AT is registered elsewhere, initiates a paging procedure to locate and activate the mobile. In this scenario, the AT responds to the page via BS2. For a handoff scenario, this step identifies and sets up the target BS.

In step h, BS2 releases the data path hold by sending an XON message to the GW. The XON message may contain a packet number or may indicate the GW should resume using the packet indicated in the XOFF message. If BS2 did not receive buffered data from BS1 or otherwise has no knowledge of what packet to resume with, the BS2 should indicate to the GW to resume with the packet indicated in the XOFF message. The GW stops timer T_{da}.

In step i, the GW sends Data to the BS2 starting with the next packet after the last packet sent from BS1 and acknowledged by the AT prior to the AT going to an hold state. The BS2 forwards the Data to the AT.

This section describes the message procedures used between the BS and GW. The interface consists of the following messages: Data, Data Available, XOFF, XON.

The Data message is the user data plan data between the BS and the GW.

The Data Available message is sent from the GW to BS.

The XOFF message sent from a BS to the GW to indicate that the GW should suspend sending of Data until an XON message is received. The XOFF message may be an “in-band” message integrated with the Data message. One method of implementing an “in-band” is to use the attribute field of the GRE protocol. An “out of band” message could be done with a signaling message from the BS to the GW.

The XON message is sent from a BS to the GW to indicate that the GW should resume sending Data to the BS. The ion message may be an “in-band” message integrated with the Data message. One method of implementing an “in-band” is to use the attribute field of the GRE protocol. An “out of band” message could be done with a signaling message from the BS to the GW.

FIG. 5 shows an example Data protocol stack. The generic route control protocol is used to provide a tunnel for connections between the BS and GW. The GRE attributes are specific to 3GPP2.

Link layer/network layer frames that are carried between the BS and the GW are encapsulated in GRE packets, which in turn are carried over IP. The BS access network-layer IP Address and the GW access-network layer IP Address are used in the source address and destination address fields of the IP header used with the GRE packet.

In the bearer traffic direction from the GW to the BS, the key field in the GRE header contains the Session Identifier (SID) that indicates to which BS-GW connection a particular payload packet belongs.

In the bearer traffic direction from the BS to the GW, the key field in the GRE header contains the SID. GRE encapsulates user traffic as shown in FIG. 6.

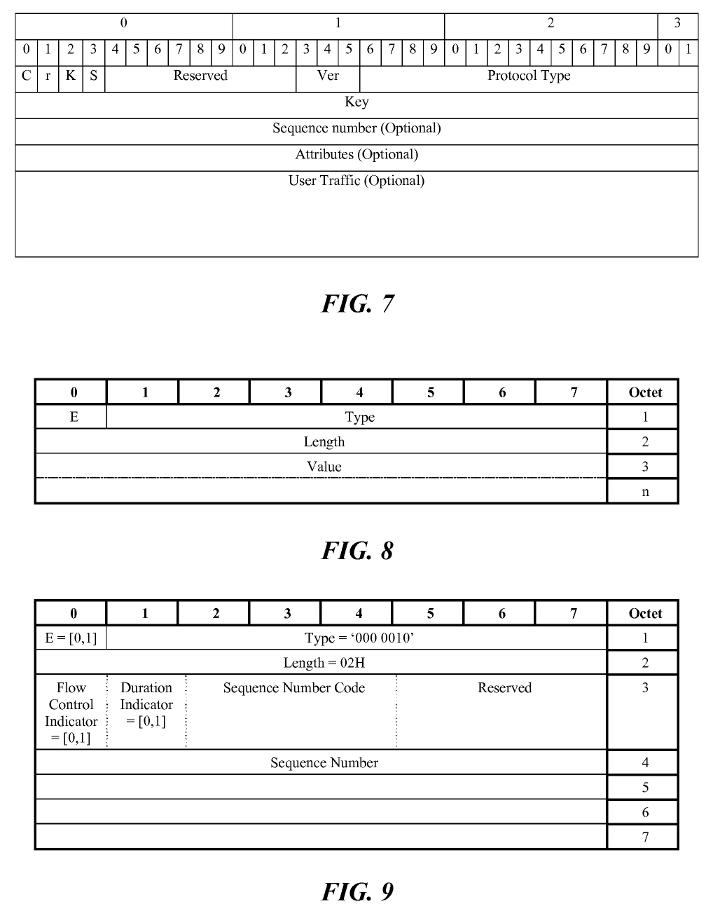

FIG. 7 shows the structure of the 3GPP2 GRE frame as used in the present invention. The 3GPP2 GRE header is encoded as follows:

C (Checksum Present) is ‘0’.

r (reserved) is ‘0’.

K (Key Present) is ‘1’.

S (Sequence Number Present) is ‘0’ or ‘1’.

Reserved is ‘000000000’.

Ver (Version Number) is ‘000’.

Protocol Type is Hex ‘88 81H’ for “Unstructured Byte Stream”, or hex ‘88 D2H’ for “3GPP2 Packet”. The protocol type shall be set to “3GPP2 Packet” only if the packet contains attributes. Otherwise it shall be set to “Unstructured Byte Stream”. If the receiving entity does not recognize the value of this field, it should discard the GRE frame.

The Key field contains a four-octet number. The Key field is used for identifying an individual U1 connection.

Sequence number is defined depending on packet delivery sequence. If the link layer/network layer protocol requires that the GRE packets be delivered in sequence (e.g. if a state-full compression mechanism is in use) over the connection, the S indicator shall be set to ‘1’ and the sequence number field shall be included in each GRE packet sent over the connection. The sequence number field is used for in-order delivery of the encapsulated user data. For each GRE connection (identified by the Key field) and direction, the sending and receiving entities shall each maintain at most one Sequence Number counter independent of the Protocol Type field. When the sequence number field is included, the sender and receiver shall perform the following: i) the sequence numbers shall be set to zero after the connection is established, ii) the sequence number shall be incremented according to [RFC2890] in each subsequent packet sent on the same connection, iii) receipt of an out-of-sequence packet on a connection shall be handled according to RFC2890.

If the Protocol Type field is set to ‘88 D2H’ for “3GPP2 Packet”, one or more attributes are included in the Attributes field. Each attribute includes four or more octets and contains information specific to the attribute. The Attribute format is as follows and in FIG. 8. The fields are transmitted from left to right.

The E bit is set to ‘1’ for the last attribute in the attribute list. It is set to ‘0’ for all other attributes.

The Type field identifies the type of attribute. If the receiving entity does not recognize the value of this field, it should discard the attribute, but process the remainder of the GRE frame.

The Length field indicates the length in octets of the Value field.

The Value field is two or more octets in length and contains information specific to the attribute. The format and length of the Value field are determined by the Type and Length fields. The Value field may contain one or more reserved bits. The sending entity shall set the reserved bits to ‘0’ and the receiving entity shall ignore the value of the reserved bits. If the receiving entity does not recognize the value of any non-reserved portion of this field, it should discard the attribute, but process the remainder of the GRE frame.

User Traffic may follow the last attribute in the attribute list, indicated by the E bit set to 1.

FIG. 9 contains the specification of attributes that may be included in a GRE frame when the Protocol Type field is set to ‘88 D2H’ for “3GPP2 Packet”. The BS may control the flow of packet data in the forward direction by including XON/XOFF signals in GRE frames sent to the GW, as follows:

Type is ‘000 0010’—Flow Control

Length is 02H

The Flow Control Indicator field contains the flow control instructions from the BS and is set in response to one or more events occurring within the RAN. It is used by the GW to determine when to stop and when to resume packet transmission for a U1 connection to the BS. This field is coded as follows:

1—XOFF: GW shall stop sending data to the BS for the U1 connection identified by “key”, on receiving this signal.

0—XON: If the GW has data available, it shall resume data transmission to the BS for the U1 connection identified by “key”, on receiving this signal. The GW shall resume transmission with the sequence number indicated in the previous XOFF message according to the following table:

If XON is from the same BS that sent the XOFF and the BS buffers data, the GW resumes transmission with the next packet that the GW would have sent to the BS prior receiving the XOFF indicator.

If XON is from the same BS that sent the XOFF indicator and the BS does not buffered data, the GW resumes transmission with the next packet that the BS is to send to the AT.

If XON is from a different BS than the one that sent the XOFF indicator and the new BS is known to have received packets buffered in the BS that sent the XOFF indication, the GW resumes transmission with the next packet that the GW would have sent to the BS prior to receiving the XOFF indicator.

If XON is from a different BS than the one that sent the XOFF indicator and the new BS has no packets buffered for this connection, then the GW resumes transmission with the next unacknowledged packet that the BS is to send to the AT.

The Duration Indicator field is valid when the Flow Control Indicator field is set to XOFF. This field is based on the event triggering flow control for the call, how long the XOFF condition is expected to last, and other information. The field is used with other information to determine if the flow-controlled packets should be buffered. The Duration Indicator can be:

0—TEMPORARY: The XOFF condition for call is expected to be temporary.

1—INDEFINITE: The XOFF condition for the call is indefinite. The GW may drop packets for the call.

The Sequence Number Code field defines whether or not the GW uses the sequence number from the XOFF or XON to resume transmission of packets to the BS. The Sequence Number Code can be:

0H—Sequence number excluded. Use sequence number, if present, from prior XOFF.

1H—Sequence number included. Use sequence number from current XON.

2H thru 7H—reserved.

The Sequence Number field contains the sequence number of the next packet that the GW is to send to the BS.

In the present invention, XOFF contains a field to indicate the last packet (or some other packet) sent to the AT, and XON contains a field to indicate whether to use the packet sequence number in the last XOFF message or whether to the packet sequence number contain in the XON message.

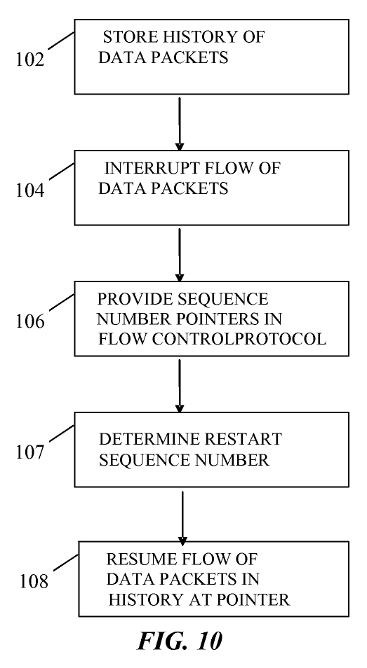

Referring to FIG. 10, the present invention includes a method for resuming an interrupted or held flow of data packets from a sender (GW) to an intermediate node (BS) in a path between the sender and a mobile device (AT).

The method includes a first step of storing 102 a history buffer of data packets sent to the mobile device. The history buffer can reside in a GW memory, or alternatively, the sender could recover packets for a history buffer by various means (e.g. an actual buffer, a BS sending packets back to the GW, requesting retransmission of packets from a sender farther in the network, etc). The history buffer of the storing step is of a sufficient size to hold an amount of packets not yet received by the mobile device. In particular, the history of the storing step has a length that is up to at least a length of the next packet to be acknowledged by the mobile device.

A next step 104 includes interrupting the flow of data packets. In one embodiment, the interrupting step occurs due to a hold state while the mobile device remains within a coverage area of the intermediate node. In another embodiment, the interrupting step occurs due to a mobility event of the mobile device moving to a coverage area of a new intermediate node.

A next step 106 includes providing a sequence number pointer in a flow control protocol to the restart sequence number determining processor. The sequence number pointer indicating a position in the flow of data packets where a last data packet was successfully obtained (i.e. a stop point) for the mobile device. In this instance the term “successfully obtained” can mean; received by the mobile device with or without acknowledgement, or buffered in the base station for later transmission to the mobile device.

If the successfully obtained data packets are data packets successfully received by the mobile device, the providing step includes sending a message to the restart sequence number determining processor with the sequence number pointer for the next packet that the sender should transmit to the mobile device through the intermediate node.

If the successfully obtained data packets are data packets successfully buffered in the intermediate node for subsequent transmission to the mobile device, the providing step includes sending a message to the restart sequence number determining processor with the sequence number pointer for the next packet the sender would have sent prior to the interrupt step.

If the interrupting step occurs due to a mobility event of the mobile device attaching to a new intermediate node, the providing step 106 further includes the step of sending a copy of data previously sent to the old intermediate node but not yet fully received by the mobile device prior to the interrupt step to the new intermediate node. The copy can be sent from either the old intermediate node or the sender.

As illustration in FIG. 11, a restart sequence number determination processor determines the actual restart sequence number to use in resuming the flow of packets.

A next step 108 includes resuming the flow of data packets from the history starting at a next packet indicated by the restart sequence number determining process. Specifically, this step includes sending a re-start message to the sender from the intermediate node covering the mobile device. The re-start message can either direct the sender to resume transmission with the next packet that the sender would have sent prior to the interrupt step, or can override this by directing the sender to resume transmissions at a data packet in the history that is different than the packet indicated by the sequence number pointer in the providing step.

If the interrupting step occurs due to a mobility event of the mobile device attaching to a new intermediate node, and if the new intermediate node has no packets buffered for this connection, then the resuming step 108 includes sending a re-start message to the sender from the new intermediate node directing the sender to resume transmission with the next un-acknowledged packet that the old intermediate node was to send to the mobile device.

In all of the above embodiments, the selection of the stop and re-start sequence number point depends on a characteristic of upper level traffic.

In a preferred embodiment, the present invention provides a method for restoring an interrupted flow of data packets from a gateway to a base station in a path between the gateway and a mobile device.

The method includes a first step of storing 102 a history of data packets sent to the mobile device.

A next step 104, 106 includes interrupting the data flow by sending an interrupt message from the base station to the gateway stopping the flow of data packets. The interrupt message providing a first sequence number pointer in a flow control protocol to the gateway that indicates a position in the flow of data packets where a last data packet was successfully obtained for the mobile device.

A next step includes determining the restart sequence number, as detailed with respect to FIG. 11 herein.

A next step 108 includes sending a resume message to the gateway to re-start the flow of data packets, the resume message providing a second sequence number pointer in a flow control protocol that indicates a next packet to be sent from the history. The first and second pointer may be the same or different.

If the resume message is sent from the same base station that sent the interrupt message and the base station buffers data, the gateway resumes transmission with the next packet that the gateway would have sent to the base station prior receiving the interrupt message.

If the resume message is sent from the same base station that sent the interrupt message and the base station does not buffered data, the gateway resumes transmission with the next packet that the base station is to send to the mobile device.

If the resume message is sent from a different base station than the one that sent the interrupt message and the new base station is known to have received packets buffered in the old base station that sent the interrupt message, the gateway resumes transmission with the next packet that the gateway would have sent to the old base station prior to receiving the interrupt message.

If the resume message is sent from a different base station than the one that sent the interrupt message and the new base station has no packets buffered for this connection, then the gateway resumes transmission with the next unacknowledged packet that the base station is to send to the mobile device.

In operation, the interrupt message performs an XOFF function and the resume message performs an XON function. The sequence number pointers are included in a message that signals the XOFF/XON function. The interrupt message and the resume message are sent on either a bearer channel or a signaling channel.

Advantageously, the present invention provides a gateway with pointers to the best packet to resume sending to a base station. Current 3GPP2, WiMax, and 3GPP communication systems have no such flexibility. By communicating the pointer to the gateway, potentially lost packets (e.g. packets that would otherwise be stranded at the base station) that matter (e.g. signaling packets) can be successfully communicated because the gateway can resend the packets from its history buffer. The present invention applies whether or not the air interface uses an acknowledgment protocol, applies whether or not the base station buffers data, applies to packets of different service type (i.e. QoS), and applies whether or not inter base station connectivity exists.

In practice, the present invention is applicable to WiMAX, 3GPP LTE, 3GPP2 UMB communication systems, IETF Mobile IP, and other communication systems that may have data “in the pipeline” as the route when the path between one route or another is interrupted. In particular, the present invention can signal a restart point other than the one following the last one transmitted for a cellular infrastructure. The present invention uses a history buffer to resend necessary packets. The present invention uses an intermediate node (e.g. base station) (as apposed to an end device) to determine the restart point. Packet flow is restarted based on network configuration: end node reception, base station buffering, inter-BS links, system load, air interface protocol mode and other factors (e.g. application traffic, QoS).

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for resuming an interrupted flow of data packets from a sender to an intermediate node in a path between the sender and a mobile device, the method comprising the steps of:
storing a history of data packets sent to the mobile device;
interrupting the flow of data packets;
providing sequence number pointers when interrupting and resuming packet flow in a flow control protocol to a restart sequence number determining processor, the sequence number pointers indicating a position for resuming the flow of data packets and
resuming the flow of data packets from the history starting at a packet indicated by the restart sequence number determining processor.

2. The method of claim 1, wherein the history of the storing step is sufficient to hold an amount of packets not yet received by the mobile device.

3. The method of claim 2, wherein the history of the storing step has a length that is up to at least a length of the next packet to be acknowledged by the mobile device.

4. The method of claim 1, wherein the interrupting step occurs due to a hold state while the mobile device remains within a coverage area of the intermediate node.

5. The method of claim 4, where if the successfully obtained data packets are data packets successfully received by the mobile device, the providing step includes sending a message to the restart sequence number determining processor with the sequence number pointer for the next packet that the sender should transmit to the mobile device through the intermediate node.

6. The method of claim 4, where if the successfully obtained data packets are data packets successfully buffered in the intermediate node for subsequent transmission to the mobile device, the providing step includes sending a message to the restart sequence number determining processor with the sequence number pointer for the next packet the sender would have sent prior to the interrupt step.

7. The method of claim 1, wherein the interrupting step occurs due to a mobility event of the mobile device attaching to a new intermediate node, and wherein after the providing step further comprising the step of sending a copy of data previously sent to the old intermediate node but not yet fully received by the mobile device prior to the interrupt step to the new intermediate node.

8. The method of claim 7, wherein the copy of the sending step is sent from one of the group of the old intermediate node and the sender.

9. The method of claim 8, wherein the resuming step includes sending a re-start message to the restart sequence number determining processor from the new intermediate node, wherein the re-start message directs the sender to resume transmissions at a data packet in the history that is different than the packet indicated by the sequence number pointer in the providing step.

10. The method of claim 8, wherein the resuming step includes sending a re-start message to the restart sequence number determining processor from the new intermediate node, wherein the re-start message directs the sender to resume transmission with the next packet that the sender would have sent to the old intermediate node prior to the interrupt step.

11. The method of claim 1, wherein the interrupting step occurs due to a mobility event of the mobile device attaching to a new intermediate node, and wherein if the new intermediate node has no packets buffered for this connection, then the resuming step includes sending a re-start message to the restart sequence number determining processor from the new intermediate node directing the restart sequence number determining processor to resume transmission with the next un-acknowledged packet that the old intermediate node was to send to the mobile device.

12. The method of claim 1, wherein the selection of the stop and re-start sequence number point depends on a characteristic of upper level traffic.

13. A method for restoring an interrupted flow of data packets from a gateway to a base station in a path between the gateway and a mobile device, the method comprising the steps of:
storing a history of data packets sent to the mobile device;
sending an interrupt message from the base station to the gateway stopping the flow of data packets, the interrupt message providing a first sequence number pointer in a flow control protocol to the gateway that a position in the flow of data packets where a last data packet was successfully obtained for the mobile device; and
sending a resume message to the gateway to re-start the flow of data packets, the resume message providing a second sequence number pointer in a flow control protocol that indicates a next packet to the sent from the history.

14. The method of claim 13, wherein if the resume message is sent from the same base station that sent the interrupt message and the base station buffers data, the gateway resuming transmission with the next packet that the gateway would have sent to the base station prior receiving the interrupt message.

15. The method of claim 13, wherein if the resume message is sent from the same base station that sent the interrupt message and the base station does not buffered data, the gateway resuming transmission with the next packet that the base station is to send to the mobile device.

16. The method of claim 13, wherein if the resume message is sent from a different base station than the one that sent the interrupt message and the new base station is known to have received packets buffered in the old base station that sent the interrupt message, the gateway resuming transmission with the next packet that the gateway would have sent to the old base station prior to receiving the interrupt message.

17. The method of claim 13, wherein if the resume message is sent from a different base station than the one that sent the interrupt message and the new base station has no packets buffered for this connection, then the gateway resuming transmission with the next un-acknowledged packet that the base station is to send to the mobile device.

18. The method of claim 13, wherein the interrupt message performs an XOFF function and the resume message performs an XON function.

19. The method of claim 13, wherein the interrupt message and the resume message are sent on one of the group of a bearer data message and a signaling message.

20. A system for resuming an interrupted flow of data packets from a sender to an intermediate node in a path between the sender and a mobile device, the method comprising the steps of:
a buffer for storing a history of data packets sent to the mobile device;
an interrupt message sent from the intermediate node to the sender for stopping the flow of data packets;
sequence number pointers sent in a flow control protocol to the restart sequence number determining processor, the sequence number pointers indicating a best position in the flow of data packets for resuming packets flow; and
a resuming packets flow from a buffer at the packet determined by the restart sequence number determining processor
